(19) United States
(12) Patent Application Publication
(10) Pub. No.: US 2005/0141870 A1
(43) Pub. Date: Jun. 30, 2005

(54) Apparatus for receiving broadcast signals and method of receiving broadcast signals

(75) Inventor: Toshiyuki Suzuki, Kumagaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/010,333

(22) Filed: Dec. 14, 2004

(30) Foreign Application Priority Data
Dec. 24, 2003 (JP) 2003-427044

(51) Int. Cl. H04N 5/76; G06F 3/00; G06F 13/00

(52) U.S. Cl. 386/83; 725/58

(57) ABSTRACT

The EPG data about the broadcast program that a user is enjoying is acquired from an EPG server via the Internet. A record format for the type of the program is prepared on the basis of the EPG data. After the user finishes enjoying the program, an answer-input menu of the record format is displayed. The menu displays questions, which the user answers. On the basis of the user's answers, a program record is prepared in the record format. The program record thus prepared is displayed.

### CROSS-REFERENCE TO RELATED APPLICATIONS

This application is based upon and claims the benefit of priority from prior Japanese Patent Application No. 2003-427044, filed Dec. 24, 2003, the entire contents of which are incorporated herein by reference.

### BACKGROUND OF THE INVENTION

1. Field of the Invention

The present invention relates to an apparatus and method for receiving broadcast signals such as digital TV signals. More particularly, the invention relates to an apparatus and method that has the function of helping the user to make a record of the TV programs he or she has enjoyed.

2. Description of the Related Art

As is known in the art, the digital television broadcasting has been promoted in recent years. Broadcasting satellite (BS) digital broadcasting and 110°-communications satellite (CS) digital broadcasting have already been practiced. Ground digital broadcasting will be soon started.

The digital TV broadcasting is performed through more and more channels. Users can therefore enjoy a great number of TV programs. A system has been put to practical use, which generates an electronic list of the programs from the electronic program guide (EPG) data which a TV receiver has received and which represents the programs that the broadcast station will broadcast.

Another system has been developed, which enables a TV receiver to acquire the EPG data from a dedicated server via an information network such as the Internet.

Most users prefer to have a record of the programs they have selected from many and appreciated. The users may add, to the record, their impression of each program, e.g., a movie program. Then, the record will be a more pleasant one.

However, no systems have been yet developed, which enable the TV receiver to cooperate with a device designed to prepare a record of the TV programs the user has appreciated.

To make a record of the programs the user has appreciated, he or she must collect information about the programs and then write the information in a notebook, or in an electronic data file by using a word-processor application.

In other words, the user needs to use a system totally independent of the TV receiver, in order to prepare and save a record of the programs he or she has appreciated. It is troublesome for the user to do so.

Such an electronic data file, to say nothing of a notebook, is no more than an item of the user's personal collection. Anybody else, for example, the producers of the TV programs, would use neither the notebook nor the electronic file. That is, the notebook or the electronic file is not put to secondary use.

As pointed out above, no systems have been developed, which enable the TV receiver to cooperate with a device designed to prepare a record of the programs the user has appreciated. Inevitably, the user must use a system utterly independent of the TV receiver to prepare and save a record of the programs he or she has appreciated. Here arise the following problems:

1. The user must collect information about the programs he or she has appreciated.

2. The user may not remember the programs well, making it difficult for he or her to prepare a record efficiently.

3. The record that the user has prepared and saved can hardly be put to secondary use, unless it is sent to the other persons.

4. The records prepared by users differ in format and contents, and will hardly be put to secondary use.

Jpn. Pat. Appln. Publication 2001-237787 discloses an apparatus for use in the interactive television service. This apparatus determines whether the audience's responses to a program are well reflected in the data to be broadcast from the broadcast station.

However, the publication teaches no measures that should be taken to solve the above-mentioned problems 1 to 4 arise when the user uses prepares and saves a record of the TV programs he or she has appreciated.

This invention has been made in view of the foregoing. An object of the invention is to provide an apparatus and method for receiving broadcast signals, which helps the user to make easily a record of the TV programs he or she has enjoyed.

### BRIEF SUMMARY OF THE INVENTION

An apparatus for receiving broadcast signals, according to the invention, comprises: a receiving unit which receives a broadcast signal; a restoring unit which restores a program from the broadcast signal received by the receiving unit; an acquiring unit which acquires data related to the program being restored by the restoring unit, from an information network; a producing unit which produces a record format for the type of the program, on the basis of the data acquired by the acquiring unit; a menu display unit which prepares an answer-input menu of the record format produced by the producing unit and which displays the answer-input menu in which items are input to be described in a program record, after the program has been restored by the restoring unit; and a program-record display unit which prepares a program record from answers input in the answer-input menu displayed by the menu display unit and which displays the program record of the record format produced by the producing unit.

A method of receiving broadcast signals, according to the invention, comprises: receiving a broadcast signal; restoring a program from the broadcast signal received; acquiring data related to the program being restored, from an information network;

producing a record format for the type of the program, on the basis of the data acquired; preparing an answer-input menu of the record format produced, and displaying the answer-input menu in which items are input to be described in a program record, after the program has been restored; and preparing a program record from answers input in the answer-input menu displayed and displaying the program record of the record format produced.

In the present invention, the data related to the program being restored from a broadcast signal received is acquired from an information network. A record format for the type of the program is produced on the basis of the data acquired. An answer-input menu of the record format is prepared and displayed after the program has been restored. In the answer-input menu, a user inputs items to be described in a program record. A program record is prepared in the record format, from the answers the user has inputs in the answer-input menu, and is displayed. The invention therefore helps the user to prepare program records easily.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of a digital TV receiver according to an embodiment of this invention;

FIG. 2 is a plan view of the remote controller for controlling the digital TV receiver shown in FIG. 1;

FIG. 3 is a flowchart explaining some major steps of the operation that the digital TV receiver performs;

FIG. 4 is a flowchart explaining the other major steps of the operation that the digital TV receiver performs;

FIG. 5 depicts an answer-input menu displayed on the digital TV receiver, in which the user may input answers to basic questions;

FIG. 6 shows another answer-input menu displayed on the digital TV receiver, in which the user may input answers to the questions the content producer asks;

FIG. 7 depicts a record displayed on the TV receiver, which concerns a TV program the user has enjoyed;

FIG. 8 depicts an answer-input menu displayed on the digital TV receiver, in which the user may input a permission or prohibition of the uploading of the program record;

FIG. 9 is a plan view of a modified remote controller for controlling the digital TV receiver shown in FIG. 1;

FIG. 10 shows a list-type selection menu displayed on the digital TV receiver, in which the user may select a list type for the program record;

FIG. 11 depicts a program-genre selection menu displayed on the digital TV receiver if the user has selected “genre” in the list-type selection menu shown in FIG. 10;

FIG. 12 depicts a list of the movies the user has enjoyed, which is displayed on the digital TV receiver if the user has selected “movies” in the program-genre selection menu shown in FIG. 11;

FIG. 13 depicts a date selection menu displayed on the digital TV receiver if the user has selected “date” in the list-type selection menu shown in FIG. 10; and

FIG. 14 depicts a record-item selection menu displayed on the digital TV receiver if the user has selected “record item” in the list-type selection menu shown in FIG. 10.

### DETAILED DESCRIPTION OF THE INVENTION

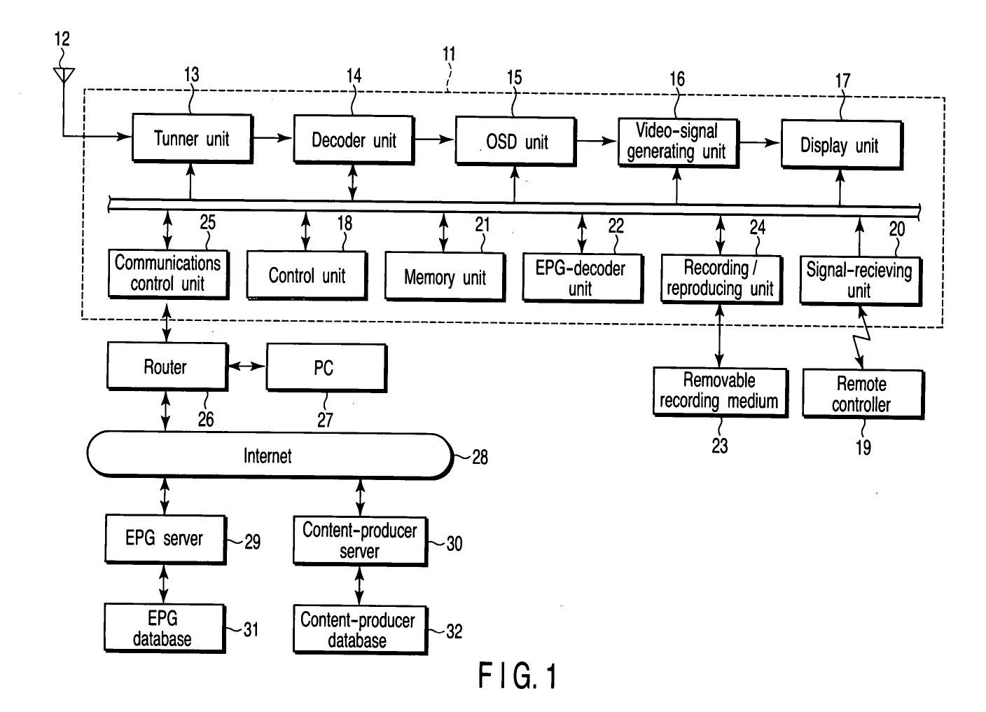

An embodiment of the invention will be described in detail, with reference to the accompanying drawings. The embodiment is a digital TV receiver. As FIG. 1 shows, the digital TV receiver 11 has a tuner unit 13, a decoder unit 14, an on-screen display (OSD) unit 15, a video-signal generating unit 16, a display unit 17, a control unit 18, a signal-receiving unit 20, a memory unit 21, an EPG-decoder unit 22, a recording/reproducing unit 24, and a communications control unit 25. The digital TV receiver 11 receives digital TV broadcast signals from an antenna 12.

In the TV receiver 11, the tuner unit 13 selects the TV broadcast signal of a desired channel. The broadcast signal selected in the tuner unit 13 is supplied to the decoder unit 14. The decoder unit 14 converts the broadcast signal to a video signal, which is supplied to the OSC unit 15. In the OSC unit 15, an OSC video signal is added to the video signal. The video signal is output to the video-signal generating unit 16.

The video-signal generating unit 16 converts the video signal to an analog video signal that the display unit 17 can process to display images. The analog video signal is output to the display unit 17, which is, for example, a cathode-ray tube (CRT). Thus, the display unit 17 displays the image represented by the analog video signal.

The control unit 18 incorporates a central processing unit (CPU). It controls the other components of the digital TV receiver 11, in accordance with various control signals supplied from a remote controller 19 via the signal-receiving unit 20.

The memory unit 21 assists the control unit 18. The memory unit 21 includes a read-only memory, a random-access memory, and a nonvolatile memory. The read-only memory stores the control program that the CPU of the control unit 18 executes. The random-access memory provides work areas the CPU may use. The nonvolatile memory stores various fixed data items, control data, an electronic list of TV programs, a program-record format, and the like. The nonvolatile memory can store program records the user may prepare.

The decoder unit 14 extracts EPG data from the TV broadcast signal the tuner unit 13 has selected. Note that the EPG data is periodically broadcast. The EPG data is supplied to the EPG-decoder unit 22 and decoded. The control unit 18 generates an electronic program table from the EPG data decoded by the EPG-decoder unit 22. The data representing the electronic program table is stored in the nonvolatile memory incorporated in the memory unit 21.

The digital TV receiver 11 has a recording/reproducing unit 24. The recording/reproducing unit 24 can hold a removable recording medium 23 such as a memory card. The control unit 18 can control the recording/reproducing unit 24 to cause the unit 24 to store the program record prepared in the removable recording medium 23.

When controlled by the communications control unit 25, the control unit 18 can be connected to an external router 26 via a local area network (LAN). A personal computer (PC) 27 can be connected to the router 26. The PC 27 may supply control signals to the control unit 18. In this case, the remote controller 19 need not supply control signals to the control unit 18.

The router 26 is connected by the telephone line to the Internet 28. Thus, the router 26 can communicate with an EPG server 29 and a content-producer server 30 through the Internet 28. This enables the control unit 18 to communicate with the EPG server 29 and content-producer server 30 via the communications control unit 25, the router 26 and the Internet 28.

The EPG server 29 can access an EPG database 31 that stores EPG data about all broadcast programs and can therefore acquire an EPG data items about the broadcast programs specified by the user. The EPG data stored in the EPG database 31 is always updated.

The content-producer server 30 can access a content-producer database 32 that stores the producers' data about the programs the producers have produced, such as questions to the users. The content-producer server 30 can therefore acquires the producers' data from the content-producer database 32. Further, the content-producer server 30 can supply the users' answers to the content-producer database 32. The users' answers can therefore be accumulated in the content-producer database 32.

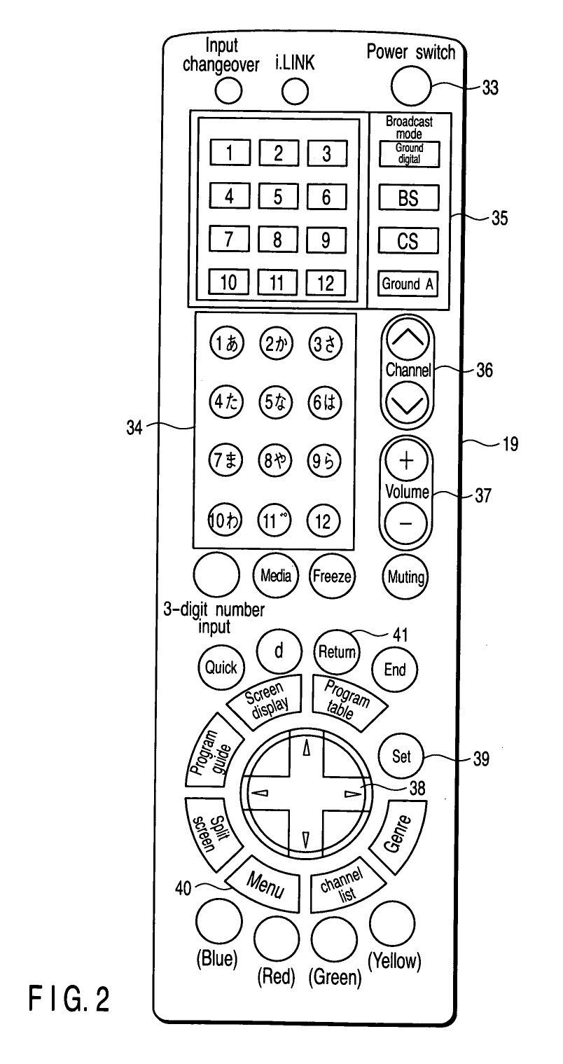

The remote controller 19 has an operation panel, which is shown in FIG. 2. The panel has a power switch 33, a channel keypad 34, a mode keypad 35, a channel shift key 36, a volume key 37, a move key 38, a set key 39, a menu key 40, and a return key 41.

The channel keypad 34 consists of 12 keys to which numerals “1” to “12” are assigned, respectively. When the user depresses the “4” key, for example, channel 4 will be selected. Ten groups of characters are assigned to the “1” to “10” keys, respectively, and punctuation marks are assigned to the “11” key. Thus, the user may depress the “1” to “11” keys to input character data.

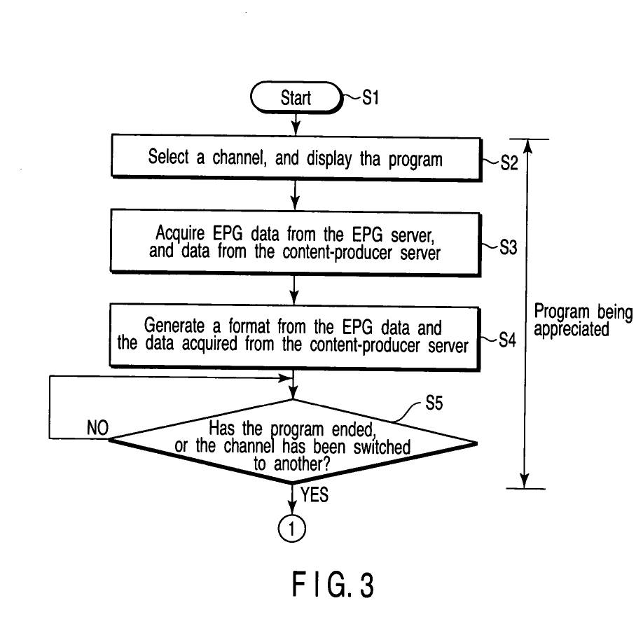

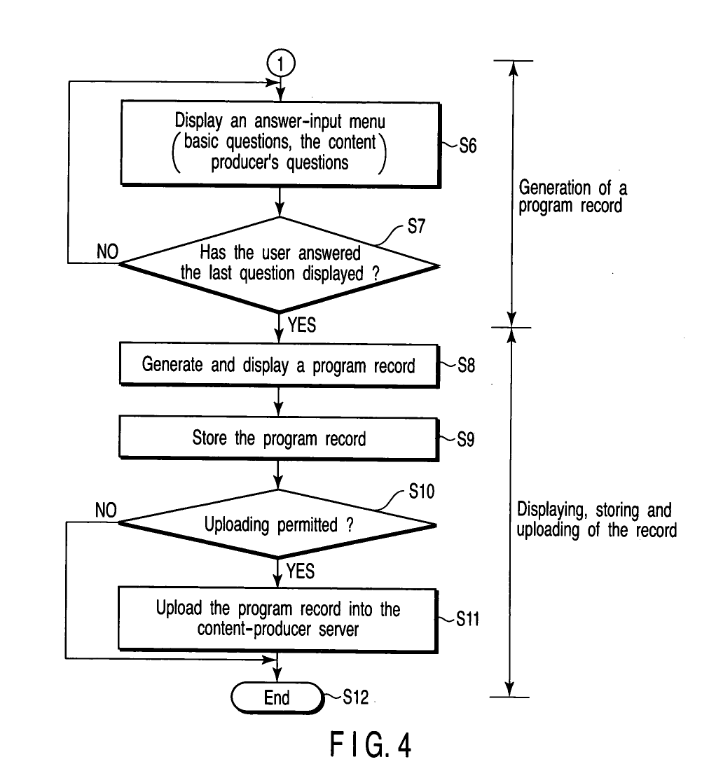

FIGS. 3 and 4 are a flowchart explaining the major steps of the operation that the digital TV receiver performs;

FIG. 4 is a flowchart explaining the other major steps of the operation that the digital TV receiver 11 performs. When the user turns on the power switch 33 provided on the remote controller 19, the TV receiver 11 starts operating (Step S1). In Step S2, the user depresses the channel keypad 34, selecting one channel. The tuner unit 13 selects the TV broadcast signal of the channel thus selected. The display unit 17 displays the program represented by the TV broadcast signal.

In Step S3, the control unit 18 accesses the EPG server 29 while the user is watching the program. Thus, the control unit 18 acquires the EPG data about the program that the display unit 17 is displaying. The EPG-decoder unit 22 decodes the EPG data, which is recorded in the nonvolatile memory incorporated in the memory unit 21.

The control unit 18 accesses the content-producer server 30, too. If the producer of the program being displayed has prepared data, e.g., questions about the program, the control unit 18 acquires this data. The data acquired is recorded in the nonvolatile memory incorporated in the memory unit 21.

In Step S4, the control unit 18 generates a format of a program record from the EPG data and the data prepared by the content producer. The format includes basic items of every kind (genre) of a TV program, so that unified program records may be prepared. If the content producer has made questions, the control unit 18 will add the questions to the basic items of the format.

In Step S5, the control unit 18 determines whether the program has ended, or whether the user has switched the channel to another before the program ends.

If YES in Step S5, the operation goes to Step S6. In Step S6, the control unit 18 causes the display unit 17 to display an answer-input menu prepared on the basis of the format generated in Step S4. Seeing this menu, the user may input answers to the questions made by the content producer.

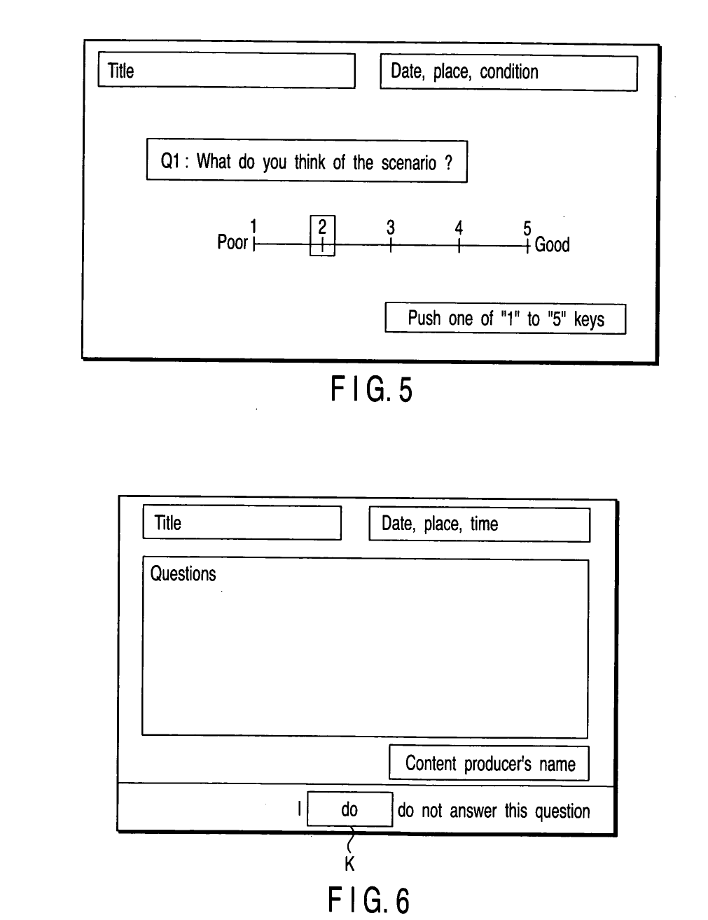

FIG. 5 depicts an example of the answer-input menu which the display unit 17 displays if the program is a movie. In the answer-input menu, the tile of the movie, the date of broadcasting the movie, and the place and condition at and in which the movie is enjoyed, on the basis of the EPG data acquired in Step S3. Question Q1, “What do you think of the scenario?” is displayed in the answer-input menu, too. Five choices of evaluation are available in the menu, one of which the user may select to evaluate the scenario.

To be more specific, the user may first depress the channel-selecting key “1,” “2,” “3,” “4” or “5” to select the one of the five choices of evaluation, and may then depress the set key 39, thereby to evaluate the scenario.

When the user finishes evaluating the scenario, the control unit 18 causes the display unit 17 to display the next answer-input menu. This menu shows several questions, asking the user to evaluate the direction, photography, art, music, acting, and the like. They user may evaluate each item, by selecting one of five choices of evaluation.

If the content producer has made questions to users, the control unit 18 causes the display unit 17 to display an answer-input menu, after the user answers the questions set about a specific type of a TV program.

FIG. 6 shows an example of this answer-input menu. In this menu, the questions are displayed one after another. The name of the content producer who has asked the questions and a message of “I do/do not answer this question” are displayed in the answer-input menu. Also displayed in this menu are the tile of the movie, the date of broadcasting the movie, and the place and condition at and in which the movie is enjoyed. The user may select either “do” or “do not” in the message.

Five choices are available for each question. The user may depress first one of the keys of the channel keypad 34 and then the set key 39, thereby to select one choice.

If the user wants to answer a question, he or she operates the move key 38, moving the cursor K to “do” in the message of “I do/do not answer the question.” Otherwise, the user operates the move key 38, moving the cursor K to “do not” and then depresses the set key 39.

In Step S7, the control unit 18 determines whether the user has answered or not answered the last question displayed in the answer-input menu shown in FIG. 6. If YES, the operation goes to Step S8. In Step S8, the control unit 18 generates a program record from the answers the user has input in the various answer-input menus. The display unit 17 displays the program record thus generated.

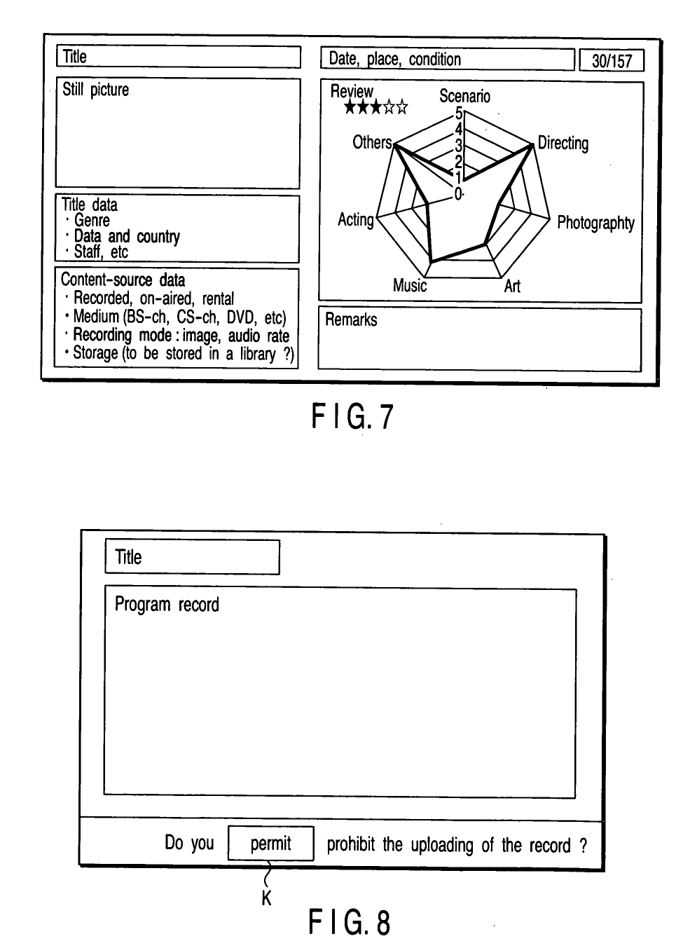

FIG. 7 depicts a program record that the unit 17 displays. This record shows the tile of the movie, the date of broadcasting the movie, and the place and condition at and in which the movie is enjoyed. The record also shows a still-picture display zone, data about the movie, data about the content source, a review chart, and a remarks zone.

Any one of the various still pictures the user has selected while enjoying the movie broadcast is displayed in the still-picture display zone. The data about the movie and the data about the content source are extracted from the EPG data and automatically displayed on the screen of the display unit 17. They may include character data that the user has input by operating the keys of the channel keypad 34.

The review chart looks like a polar chart and represents the values the user has determined of the direction, photography, art, music, acting, and the like. In the remarks zone, the user may write his impression of the movie, by operating the keys of the channel keypad 34.

The user's answers to the content producer's questions may be reflected in the program record. Thus, the format in which the program record is displayed my be altered in accordance with the type of the program, the number of the producer's questions and the types of the producer's questions.

In Step S9, the control unit 18 stores the program record thus generated, in the nonvolatile memory incorporated in the memory unit 21 or in the removable recording medium 23 held in the recording/reproducing unit 24. The user may operate the remote controller 19 to select the nonvolatile memory or the recording medium 23, as record-storing device.

In Step S10, the control unit 18 causes the display unit 17 to display an answer-input menu, in which a question is displayed, asking the user whether the program record should be uploaded into the content-producer server 30. That is, it is determined whether the record should be uploaded into the server 30.

FIG. 8 shows an example of this answer-input menu. In this menu, the question of “Do you permit/prohibit the uploading of the record?” is displayed. The title of the program is displayed in this menu, too.

The user may first operate the move key 38, moving the cursor K to “permit” in the question, and may then depress the set key 39. In this case, the program record is uploaded into the content-producer server 30. The user may move the cursor K to “prohibit” and then depresses the set key 39, thereby to prohibit the uploading of the program record.

If YES in Step S10, or if the user moves the cursor K to “permit,” the operation goes to Step S11. In Step S11, the control unit 18 supplies the program record to the content-producer server 30, and the record is loaded into the server 30. Thus, the operation ends in Step S12. If NO in Step S10, the operation jumps to Step S12.

In the embodiment described above, the EPG data is acquired and described in the record about a program while the user is enjoying the program. Thus, the user need not acquire the data about the program. This renders it easy for the user to prepare the record about the program.

As specified above, questions are displayed in various answer-input menus displayed by the display unit 17. This encourages the user to prepare a record about the program that he or she has just enjoyed. As a result, more program records are prepared than otherwise.

When questions of specific types are displayed in any answer-input menu, several choices of answer are displayed for each of these questions. In this case, the user only needs to select one of the choices. This makes it easy for the user to prepare the record about the program. Thus, more program records are prepared than otherwise.

Various formats of program records are preset, each for programs of a specific type. Hence, records of programs of the same type can be provided in the same format. The records thus provided are unified ones. Such unified records may be put to secondary use. That is, they may be used by persons other than the user.

The digital TV receiver 11 acquires the questions the content producer has made about a program, through the Internet 28. The receiver 11 transmits the record of the program, containing the user's answers to the questions, to the content producer through the Internet 28. This helps encourage the secondary use of the record.

The content producer is not the sole secondary user. Any other person and any organization whose digital TV receiver can be connected to the Internet 28 can use the record that the user has prepared. Being an electronic one, the record can be distributed for sale. Records prepared by many users may publish on the Internet. Statistical data about such records may be provided through the Internet. The records prepared by each user may be analyzed in order to provide a list of programs to be broadcast, which may interest the user.

In the embodiment described above, the user operates the channel keypad 34 of the remote controller 19 in order to add character data to a program record. Instead, the user may operate, for example, the keyboard of the PC 27 to input the character data.

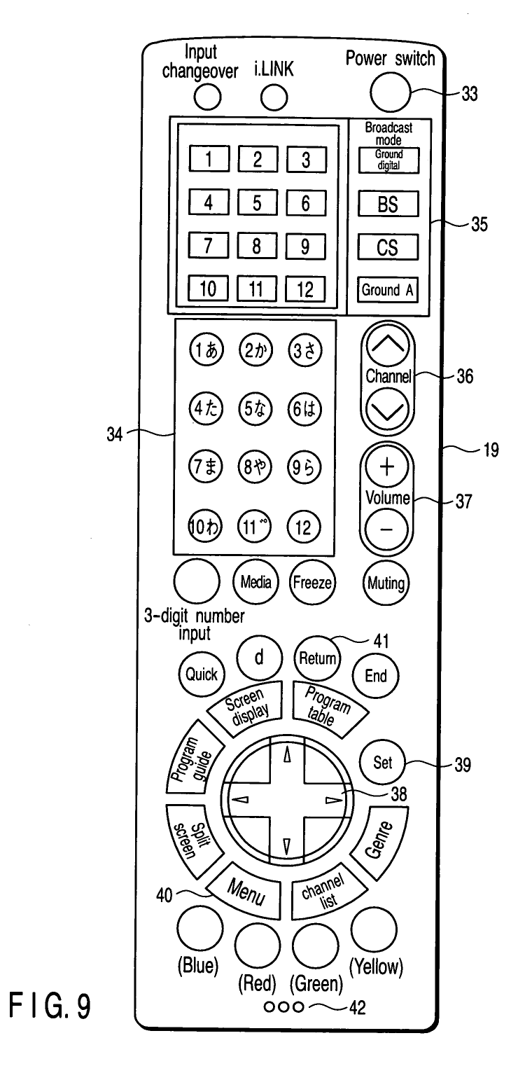

Alternatively, the remote controller 19 may have a microphone 42 as is illustrated in FIG. 9. In this case, the user talks to the microphone 42, and the microphone generates an audio signal. The audio signal is supplied to the control unit 18. The unit 18 converts the audio signal to text data, which is added to the program record.

The display unit 17 can display a list of the program records stored in the nonvolatile memory provided in the memory unit 21 or in the removable recording medium 23 held in the recording/reproducing unit 24. How this list is displayed will be explained. To display the list, the user depresses the menu key 40 provided on the remote controller 19, selecting the record-list displaying that is one of the menu items displayed on the display unit 17.

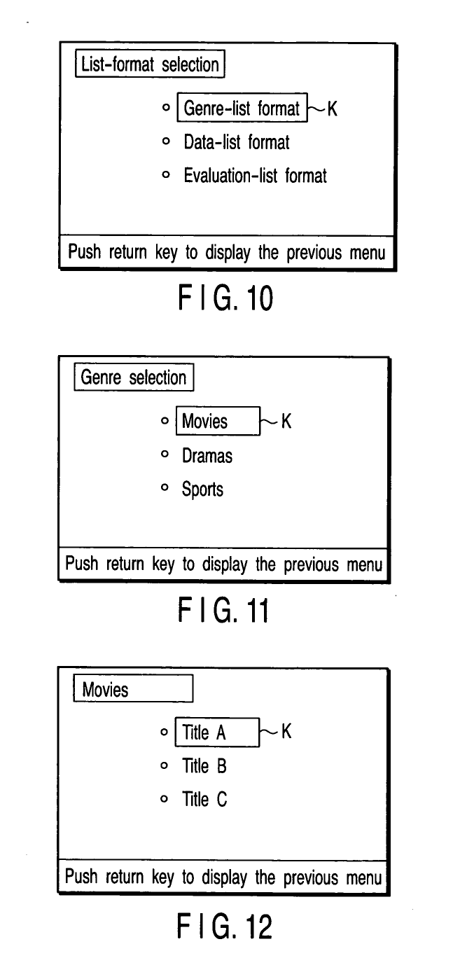

When the user selects the record-list displaying, the control unit 18 causes the display unit 17 to display a list-format selection menu shown in FIG. 10. The list-format selection menu shows various list formats, e.g., genre-list format, date-list format, and evaluation-list format. The user first operates the move key 38, moving the cursor K to a desired list format, and then depress the set key 39, thus selecting the list format.

Assume that the user selects the genre-list format in the list-format selection menu as shown in FIG. 10. Then, the control unit 18 causes the display unit 17 to display a genre-selecting menu shown in FIG. 11. The genre-selecting menu shows several genres of programs, such as movies, dramas and sports. The user first operates the move key 38, moving the cursor K to a desired genre, and then depress the set key 39, thus selecting the genre.

The user may select movies in the genre-selecting menu, as is illustrated in FIG. 11. In this case, the control unit 18 reads the records about movies from the nonvolatile memory provided in the memory unit 21 or from the removable recording medium 23 held in the recording/reproducing unit 24. The control unit 18 causes the display unit 17 to display a list of the movies, more precisely a list of the movie titles, as is illustrated in FIG. 12.

The user first operates the move key 38, moving the cursor K to a desired movie tile, and then depress the set key 39, thus selecting the movie as shown in FIG. 12. As a result, the display unit 17 displays the program record about the movie, as is illustrated in FIG. 7.

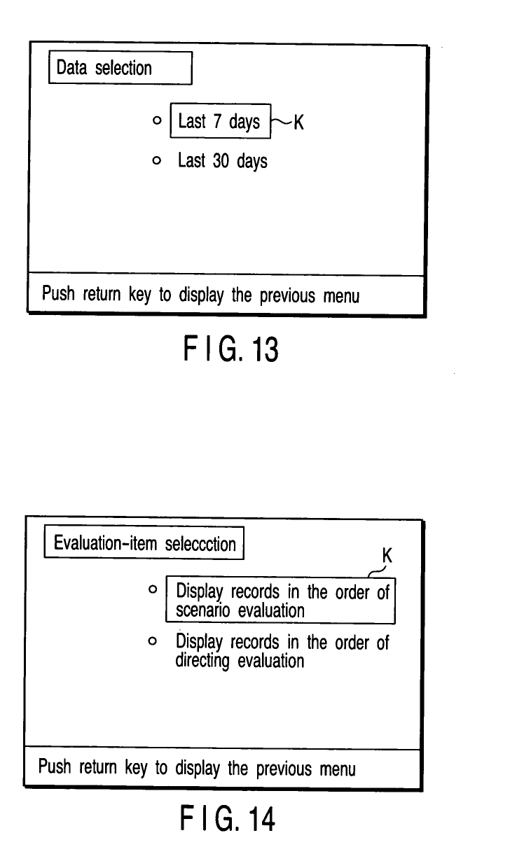

Assume that the user selects the date-list format in the list-format selection menu (FIG. 10). In this case, the control unit 18 causes the display unit 17 to display a date-selecting menu shown in FIG. 13. The date-selecting menu shows several time-periods, such as “last 7 days” and “last 30 days.” The user first operates the move key 38, moving the cursor K to a desired period, and then depress the set key 39, thus selecting the period. If the user selects “last 7 days,” the control unit 18 will make the display unit 17 display a list of the records about all programs the user enjoyed in the last seven days.

The user may select the evaluation-list format in the list-format selection menu (FIG. 10). In this case, the control unit 18 causes the display unit 17 to display an evaluation-item selecting menu shown in FIG. 14. If the user has already selected movies in the genre-selecting menu as shown in FIG. 11, the display unit 17 displays several evaluation items, such as scenario evaluation and direction evaluation. The user first operates the move key 38, moving the cursor K to a desired evaluation item, and then depress the set key 39, thus selecting the evaluation item. Then, the control unit 18 will make the display unit 17 display a list of the records about all programs the user enjoyed, in ascending or descending order of evaluation.

The present invention is not limited to the embodiments described above. The components of the embodiment can be modified in various manners in reducing the invention to practice, without departing from the sprit or scope of the invention. Further, the components of any embodiment described above may be combined, if necessary, in various ways to make different inventions. For example, some of the component of the embodiment may not be used.

1. An apparatus for receiving broadcast signals, comprising:
a receiving unit which receives a broadcast signal;
a restoring unit which restores a program from the broadcast signal received by the receiving unit;
an acquiring unit which acquires data related to the program being restored by the restoring unit, from an information network;
a producing unit which produces a record format for the type of the program, on the basis of the data acquired by the acquiring unit;
a menu display unit which prepares an answer-input menu of the record format produced by the producing unit and which displays the answer-input menu in which items are input to be described in a program record, after the program has been restored by the restoring unit; and
a program-record display unit which prepares a program record from answers input in the answer-input menu displayed by the menu display unit and which displays the program record of the record format produced by the producing unit.

2. The apparatus according to claim 1, further comprising a recording unit which records the program record prepared by the program-record display unit, in a recording medium.

3. The apparatus according to claim 1, further comprising a transmitting unit which transmits data representing the program record prepared by the program-record display unit, in response to a request coming through the information network.

4. The apparatus according to claim 1, wherein upon receipt of a request for adding an item to the program record, coming through the information network, the producing unit produces a record format corresponding to the type of the program, on the basis of the data acquired by the acquiring unit and the item to be added to the program record.

5. The apparatus according to claim 2, wherein upon receipt of a request for adding an item to the program record, coming through the information network, the producing unit produces a record format corresponding to the type of the program, on the basis of the data acquired by the acquiring unit and the item to be added to the program record.

6. The apparatus according to claim 3, wherein upon receipt of a request for adding an item to the program record, coming through the information network, the producing unit produces a record format corresponding to the type of the program, on the basis of the data acquired by the acquiring unit and the item to be added to the program record.

7. The apparatus according to claim 4, wherein the menu display unit displays a message in the answer-input menu, asking whether a user wants to answer a question about the item to be added to the program record.

8. The apparatus according to claim 5, wherein the menu display unit displays a message in the answer-input menu, asking whether a user wants to answer a question about the item to be added to the program record.

9. The apparatus according to claim 6, wherein the menu display unit displays a message in the answer-input menu, asking whether a user wants to answer a question about the item to be added to the program record.

10. The apparatus according to claim 7, wherein the menu display unit displays a message in the answer-input menu, asking whether the data representing the program record can be transmitted to the information network.

11. The apparatus according to claim 8, wherein the menu display unit displays a message in the answer-input menu, asking whether the data representing the program record can be transmitted to the information network.

12. The apparatus according to claim 9, wherein the menu display unit displays a message in the answer-input menu, asking whether the data representing the program record can be transmitted to the information network.

13. The apparatus according to claim 10, further comprising a list-displaying unit which retrieves a specific item of each program record prepared by the program-record display unit and displays a list showing the retrieved items of program records.

14. The apparatus according to claim 11, further comprising a list-displaying unit which retrieves a specific item of each program record prepared by the program-record display unit and displays a list showing the retrieved items of program records.

15. The apparatus according to claim 12, further comprising a list-displaying unit which retrieves a specific item of each program record prepared by the program-record display unit and displays a list showing the retrieved items of program records.

16. A method of receiving broadcast signals, comprising:
receiving a broadcast signal;
restoring a program from the broadcast signal received;
acquiring data related to the program being restored, from an information network;
producing a record format for the type of the program, on the basis of the data acquired;
preparing an answer-input menu of the record format produced, and displaying the answer-input menu in which items are input to be described in a program record, after the program has been restored; and
preparing a program record from answers input in the answer-input menu displayed and displaying the program record of the record format produced.

17. The method according to claim 16, further comprising recording the program record in a recording medium.

18. The method according to claim 16, further comprising transmitting data representing the program record in response to a request coming through the information network.
